(19) United States
(12) Patent Application Publication
(10) Pub. No.: US 2024/0420864 A1
(43) Pub. Date: Dec. 19, 2024

(54) PROTECTIVE TAPE MEMBER AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Taiji MOCHIZUKI, Osaka (JP); Shigeto KATO, Osaka (JP)

(21) Appl. No.: 18/702,059

(22) PCT Filed: Oct. 14, 2022
(86) PCT No.: PCT/JP2022/038411

§ 371 Date: Apr. 17, 2024

(30) Foreign Application Priority Data
Oct. 19, 2021 (JP) 2021-170963

(51) Int. Cl. H01B 7/00; H01B 7/28

(52) U.S. Cl. CPC H01B 7/0045; H01B 7/28

(57) ABSTRACT

A first tape member according to one aspect of the present disclosure is a protective tape member that protects at least one electric wire from foreign matter that comes into contact with a wire harness including the at least one electric wire. The first tape member includes a first base material that is band-shaped and has a first surface and a second surface on a side opposite to the first surface, and a first adhesive layer laminated on the second surface. A length direction of the first base material is a direction orthogonal to a width direction of the first base material. The first base material has, on the first surface, a plurality of protruding portions extending continuously along the width direction. The plurality of protruding portions are arranged side by side in the length direction of the first base material.

### TECHNICAL FIELD

The present disclosure relates to a protective tape member and a wire harness.

### BACKGROUND

Conventionally, some wire harnesses mounted in vehicles include a corrugated tube as an exterior member.

Also, in a wire harness described in Patent Document 1, instead of the corrugated tube, a wear-resistant tape made of fiber-reinforced resin is used as an exterior member while being half-wrapped around the outer periphery of an electric wire.

### PRIOR ART DOCUMENT

### Patent Document

Patent Document 1: JP 2003-272447 A

### SUMMARY OF THE INVENTION

### Problems to be Solved

When using a corrugated tube, a step of fixing the corrugated tube to the electric wire, such as fixing the corrugated tube to the electric wire with a tape member, is performed.

On the other hand, in the wire harness described in Patent Document 1, in order to give the exterior member made of a tape member the same strength as a corrugated tube, it is necessary to make the thickness of the exterior member equal to that of the corrugated tube. For this reason, the tape member is wrapped around the outer periphery of the electric wire multiple times, or the thickness of the base material of the tape member is increased.

An object of the present disclosure is to provide a protective tape member that can easily form an exterior member with the same thickness and strength as a corrugated tube, and a wire harness that includes an exterior member formed by the protective tape.

### Means to Solve the Problem

A protective tape member according to the present disclosure is a protective tape member for protecting at least one electric wire from foreign matter that comes into contact with a wire harness including the at least one electric wire, including: a base member that is band-shaped and has a first surface and a second surface on a side opposite to the first surface; and an adhesive layer laminated on the second surface, in which a length direction of the base material is a direction orthogonal to a width direction of the base material, the base material has, on the first surface, a plurality of protruding portions extending continuously along the width direction of the base material, and the plurality of protruding portions are arranged side by side in the length direction of the base material.

A protective tape member according to the present disclosure is a protective tape member for protecting at least one electric wire from foreign matter that comes into contact with a wire harness including the at least one electric wire, including: a base member that is band-shaped and has a first surface and a second surface on a side opposite to the first surface; and an adhesive layer laminated on the second surface, in which a length direction of the base material is a direction orthogonal to a width direction of the base material, the base material has, on the first surface, a plurality of protruding portions extending continuously along the length direction of the base material, and the plurality of protruding portions are arranged side by side in the width direction of the base material.

A protective tape member according to the present disclosure is a protective tape member for protecting at least one electric wire from foreign matter that comes into contact with a wire harness including the at least one electric wire, including: a base member that is band-shaped and has a first surface and a second surface on a side opposite to the first surface; and an adhesive layer laminated on the second surface, in which a length direction of the base material is a direction orthogonal to a width direction of the base material, the base material has, on the first surface, a plurality of protruding portions extending continuously along a reference direction that intersects the direction of the base material and intersects the length direction of the base material in a view from the thickness direction of the base material, and the plurality of protruding portions are arranged side by side in the length direction of the base material.

A wire harness according to the present disclosure is a wire harness including an electric wire bundle including a plurality of electric wires, in which the electric wire bundle includes a flat portion in which the plurality of electric wires are arranged side by side in a flat manner, in at least a portion in a direction in which the electric wire bundle extends, the wire harness further includes an exterior member that protects the flat portion, the exterior member has a first tape member and a second tape member that sandwich the flat portion from both sides of the flat portion in a thickness direction, the first tape member is the above-described protective tape member, which is affixed to the flat portion by the adhesive layer, and the second tape member is the above-described protective tape member, which is affixed to the flat portion by the adhesive layer.

A wire harness according to the present disclosure is a wire harness including an electric wire bundle including a plurality of electric wires, in which the electric wire bundle includes a flat portion in which the plurality of electric wires are arranged side by side in a flat manner in at least a portion in a direction in which the electric wire bundle extends, the wire harness further includes an exterior member that protects the flat portion, the exterior member has a first tape member and a second tape member that sandwich the flat portion from both sides of the flat portion in a thickness direction, each of the first tape member and the second tape member is the above-described protective tape member, which is affixed to the flat portion by the adhesive layer.

A wire harness according to the present disclosure is a wire harness including an electric wire bundle including a plurality of electric wires, in which the electric wire bundle includes a flat portion in which the plurality of electric wires are arranged side by side in a flat manner in at least a portion in a direction in which the electric wire bundle extends, the wire harness further includes an exterior member that protects the flat portion, the exterior member has a first tape member and a second tape member that are affixed to each other sandwiching the flat portion from both sides of the flat portion in a thickness direction, the first tape member is the above-described protective tape member, which is affixed to the flat portion by the adhesive layer, and letting the base material of the first tape member be a first base material and the adhesive layer of the first tape member be a first adhesive layer, the second tape member includes a second base material that is band-shaped and thinner than the first base material, and a second adhesive layer that is laminated on one surface of the second base material.

A wire harness according to the present disclosure is a wire harness including: at least one electric wire; and an exterior member formed by the above-described protective tape member, in which the protective tape member is spirally wrapped around an outer periphery of the at least one electric wire such that portions of the protective tape member in a width direction overlap.

### Effect of the Invention

According to the protective tape member and wire harness of the present disclosure, an exterior member having the same thickness and strength as a corrugated tube can be easily obtained.

### BRIEF DESCRIPTION OF THE DRAWINGS

FIG. 1 is a perspective view schematically showing a wire harness according to a first embodiment.

FIG. 2 is a vertical cross-sectional view schematically showing the wire harness according to the first embodiment.

FIG. 3 is an illustrative diagram for describing a step of manufacturing the protective tape member in the first embodiment.

FIG. 4 is an illustrative diagram for describing the step of manufacturing the protective tape member in the first embodiment.

FIG. 5 is a side view schematically showing the protective tape member of the first embodiment.

FIG. 6 is a schematic diagram showing a state in which the protective tape member of the first embodiment is wrapped around a paper tube.

FIG. 7 is a perspective view schematically showing a wire harness according to a second embodiment.

FIG. 8 is a cross-sectional view schematically showing the wire harness according to the second embodiment.

FIG. 9 is a perspective view schematically showing a wire harness according to a third embodiment.

FIG. 10 is a plan view schematically showing the wire harness according to the third embodiment.

FIG. 11 is a schematic diagram of a wire harness in a modified example.

FIG. 12 is an end view schematically showing the wire harness in the modified example shown in FIG. 11.

FIG. 13 is a schematic diagram of the wire harness in the modified example.

FIG. 14 is a perspective view schematically showing the wire harness in the modified example.

FIG. 15 is a perspective view schematically showing the wire harness in the modified example.

FIG. 16 is a perspective view schematically showing the wire harness in the modified example.

FIG. 17 is a cross-sectional view schematically showing the wire harness in the modified example.

FIG. 18 is a side view schematically showing a protective tape member in a modified example.

### DETAILED DESCRIPTION TO EXECUTE THE INVENTION

### Description of Embodiments of the Present Disclosure

First, embodiments of the present disclosure will be listed and described.

[1] A protective tape member according to the present disclosure is a protective tape member for protecting at least one electric wire from foreign matter that comes into contact with a wire harness including the at least one electric wire, including: a base member that is band-shaped and has a first surface and a second surface on a side opposite to the first surface; and an adhesive layer laminated on the second surface, in which a length direction of the base material is a direction orthogonal to a width direction of the base material, the base material has, on the first surface, a plurality of protruding portions extending continuously along the width direction of the base material, and the plurality of protruding portions are arranged side by side in the length direction of the base material.

According to this configuration, by bringing at least a portion of the adhesive layer into areal contact with the outer peripheral surface of the electric wire, the protective tape member can be affixed to the outer peripheral surface of the electric wire. By affixing the protective tape member to the outer peripheral surface of the electric wire, an exterior member that protects the electric wire can be formed by the protective tape member. Also, the plurality of protruding portions allow the maximum thickness of the protective tape member to be easily increased, and the strength of the protective tape member to be easily increased. Accordingly, by forming an exterior member using the protective tape member, it is easier to form an exterior member with the same thickness and strength as a corrugated tube, compared to the case of forming an exterior member using a conventional tape member that does not have a protruding portion.

[2] It is preferable that both end regions of the base member in the length direction include adhesion portions at which both end regions of the base material in the length direction of the base material are adhered to an outer peripheral surface of the at least one electric wire by the adhesive layer.

According to this configuration, it is possible to suppress the protective tape member from peeling off of the outer peripheral surface of the electric wire.

[3] A protective tape member according to the present disclosure is a protective tape member for protecting at least one electric wire from foreign matter that comes into contact with a wire harness including the at least one electric wire, including: a base member that is band-shaped and has a first surface and a second surface on a side opposite to the first surface; and an adhesive layer laminated on the second surface, in which a length direction of the base material is a direction orthogonal to a width direction of the base material, the base material has, on the first surface, a plurality of protruding portions extending continuously along the length direction of the base material, and the plurality of protruding portions are arranged side by side in the width direction of the base material.

According to this configuration, the same effects as those of the above-mentioned protective tape member can be achieved.

[4] It is preferable that the protective tape member being used as at least one of two tape members in an exterior member formed by the two tape members, which are affixed to each other while sandwiching the at least one electric wire from both sides in a direction orthogonal to the length direction of the at least one electric wire, and the protective tape member further includes: an accommodation portion that is recessed in a direction from the second surface to the first surface, extends in the length direction of the base material, and in which a portion of the at least one electric wire in the length direction is arranged; and end portion affixing portions that are located on both sides of the accommodation portion in the width direction of the base material and are affixed to the partner-side tape member by the adhesive layer.

According to this configuration, since one tape member can be affixed to the end portion affixing portion of the other tape member, it is easier to affix the two tape members constituting the exterior member to each other. Also, at least a portion of the electric wire in the length direction of the electric wire can be easily surrounded over the entire periphery by the two tape members.

[5] A protective tape member according to the present disclosure is a protective tape member for protecting at least one electric wire from foreign matter that comes into contact with a wire harness including the at least one electric wire, including: a base member that is band-shaped and has a first surface and a second surface on a side opposite to the first surface; and an adhesive layer laminated on the second surface, in which a length direction of the base material is a direction orthogonal to a width direction of the base material, the base material has, on the first surface, a plurality of protruding portions extending continuously along a reference direction that intersects the direction of the base material and intersects the length direction of the base material in a view from the thickness direction of the base material, and the plurality of protruding portions are arranged side by side in the length direction of the base material.

According to this configuration, the same effects as those of the above-described protective tape member can be achieved.

[6] A wire harness of the present disclosure is a wire harness including an electric wire bundle including a plurality of electric wires, in which the electric wire bundle includes a flat portion in which the plurality of electric wires are arranged side by side in a flat manner, in at least a portion in a direction in which the electric wire bundle extends, the wire harness further includes an exterior member that protects the flat portion, the exterior member has a first tape member and a second tape member that sandwich the flat portion from both sides of the flat portion in a thickness direction, the first tape member is the above-described protective tape member, which is affixed to the flat portion by the adhesive layer, and the second tape member is the above-described protective tape member, which is affixed to the flat portion by the adhesive layer.

According to this configuration, the same effects as those of the above-described protective tape member can be achieved. In particular, since each of the first tape member and the second tape member can be affixed to the flat portion using the adhesive layer, each of the first tape member and the second tape member can be easily arranged with respect to the flat portion. That is, the exterior member can be easily attached to the electric wire.

[7] A wire harness of the present disclosure is a wire harness including an electric wire bundle including a plurality of electric wires, in which the electric wire bundle includes a flat portion in which the plurality of electric wires are arranged side by side in a flat manner, in at least a portion in a direction in which the electric wire bundle extends, the wire harness further includes an exterior member that protects the flat portion, the exterior member has a first tape member and a second tape member that sandwich the flat portion from both sides of the flat portion in a thickness direction, the first tape member is the above-described protective tape member, which is affixed to the flat portion by the adhesive layer, and the second tape member is the above-described protective tape member, which is affixed to the flat portion by the adhesive layer.

According to this configuration, the same effects as the above-described wire harness can be achieved.

[8] A wire harness of the present disclosure is a wire harness including an electric wire bundle including a plurality of electric wires, in which the electric wire bundle includes a flat portion in which the plurality of electric wires are arranged side by side in a flat manner in at least a portion in a direction in which the electric wire bundle extends, the wire harness further includes an exterior member that protects the flat portion, the exterior member has a first tape member and a second tape member that sandwich the flat portion from both sides of the flat portion in a thickness direction, each of the first tape member and the second tape member is the above-described protective tape member, which is affixed to the flat portion by the adhesive layer.

According to this configuration, the same effects as the above-described wire harness can be achieved.

[9] A wire harness of the present disclosure is a wire harness including an electric wire bundle including a plurality of electric wires, in which the electric wire bundle includes a flat portion in which the plurality of electric wires are arranged side by side in a flat manner in at least a portion in a direction in which the electric wire bundle extends, the wire harness further includes an exterior member that protects the flat portion, the exterior member has a first tape member and a second tape member that are affixed to each other sandwiching the flat portion from both sides of the flat portion in a thickness direction, the first tape member is the above-described protective tape member according to any one of claims 1 to 5, which is affixed to the flat portion by the adhesive layer, and letting the base material of the first tape member be a first base material and the adhesive layer of the first tape member be a first adhesive layer, the second tape member includes a second base material that is band-shaped and thinner than the first base material, and a second adhesive layer that is laminated on one surface of the second base material.

According to this configuration, the flat portion can be protected by the first tape member by arranging the first tape member on the side that may come into contact with foreign matter out of the two sides in the thickness direction of the flat portion, while the protective tape member (first tape member) and the second tape member are used together.

A wire harness of the present disclosure is a wire harness including: at least one electric wire; and an exterior member formed by the above-described protective tape member, in which the protective tape member is spirally wrapped around an outer periphery of the at least one electric wire such that portions of the protective tape member in the width direction overlap.

According to this configuration, a portion of the first-wrapped protective tape member in the width direction and a portion of the later-wrapped protective tape member in the width direction to be adhered to each other by the adhesive layer of the later-wrapped protective tape member. Accordingly, the spirally-wrapped protective tape member forms a cylinder that surrounds the outer periphery of the electric wire. Then, the cylinder formed by the protective tape member can protect the electric wire from foreign matter that comes into contact with the wire harness. In this manner, by spirally wrapping the protective tape member around the outer periphery of the electric wire, an exterior member having the same thickness and strength as a corrugated tube can be easily formed.

Also, since the protective tape member can be affixed to the outer peripheral surface of the electric wire using the adhesive layer, there is no need to perform a step of fixing the exterior member formed by the protective tape member to the electric wire using a separate fixing tape member or the like. Accordingly, there is no need to perform a step of fixing a corrugated tube to the electric wire with a tape member or a step of wrapping the tape member around the outer periphery of the corrugated tube, which are performed when a corrugated tube is used as the exterior member. That is, the number of work steps can be reduced compared to the case where a corrugated tube is used as the exterior member. Accordingly, the exterior member can be easily attached to the electric wire.

It is preferable that the exterior member is formed by the above-described protective tape member, and each of the plurality of protruding portions extends along the length direction of the at least one electric wire in the outer periphery of the at least one electric wire.

According to this configuration, the shape of the electric wire is easier to keep in a linear shape while rigidity is provided by the exterior member in the portion where the electric wire is to be kept in a linear shape. Accordingly, bending of the wire harness can be suppressed in the portion where the wire harness is to be kept in a linear shape.

### DETAILS OF EMBODIMENTS OF THE PRESENT DISCLOSURE

Specific examples of the protective tape member and wire harness of the present disclosure will be described below with reference to the drawings. Note that the present invention is not limited to these examples, but is indicated by the scope of the claims, and all changes within the meaning and scope equivalent to the scope of the claims are intended to be incorporated therein. Also, the accompanying drawings show components in an enlarged manner in some cases for ease of understanding. In the accompanying drawings, the dimensional proportions of the components differ from those in reality or from those in other drawings in some cases.

### First Embodiment

A first embodiment of a protective tape member and a wire harness will be described hereinafter.

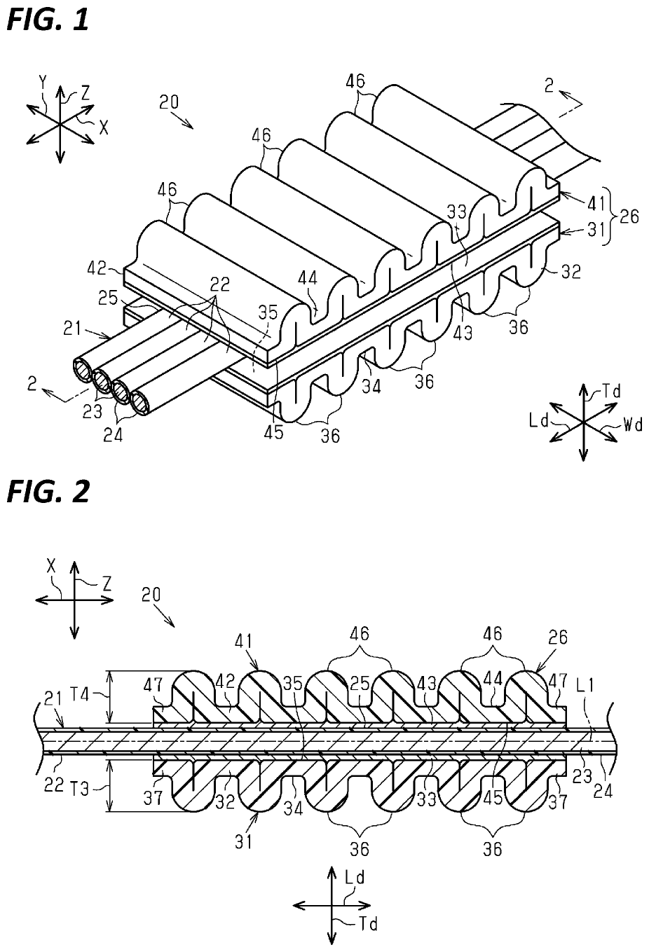

The wire harness 20 shown in FIG. 1 is mounted in a vehicle such as an automobile, for example. The wire harness 20 includes, for example, an electric wire bundle 21. The electric wire bundle 21 has a plurality of electric wires 22. For example, the electric wire bundle 21 has four electric wires 22. The four electric wires 22 are, for example, the same type of electric wire and have the same diameter. The electric wire bundle 21 is a bundle of the plurality of electric wires 22.

As shown in FIGS. 1 and 2, each electric wire 22 includes a conductive core wire 23 and an insulating coating 24 that surrounds the outer periphery of the core wire 23 and has insulative properties. Note that FIG. 2 is a cross-sectional view taken along line 2-2 in FIG. 1.

For example, a twisted wire made by twisting a plurality of metal wires together, a columnar conductor made of one columnar metal rod with a solid structure inside, a cylindrical conductor with a hollow structure inside, or the like can be used as the core wire 23. Also, for example, a combination of at least two of a twisted wire, a columnar conductor, and a cylindrical conductor may be used as the core wire 23. As the material of the core wire 23, for example, a metal material that is copper-based, aluminum-based, or the like can be used.

For example, the insulating coating 24 covers the outer periphery of the core wire 23 over the entire periphery in the peripheral direction around a center line L1 of the electric wire 22. The insulating coating 24 is made of, for example, a resin material having insulative properties. Note that the center line L1 is illustrated by a one-dot chain line only in FIG. 2. The center line L1 is a line passing through the center of the transverse cross section of the electric wire 22. A length direction of the electric wires 22 extends along the center line L1.

A connector (not shown) is provided at the end of each electric wire 22. The connector includes a connector housing and a connection terminal held inside the connector housing. The plurality of electric wires 22 are electrically connected to respectively different connection terminals.

The electric wire bundle 21 has a flat portion 25 in which the plurality of electric wires 22 are arranged side by side in a flat manner in at least a portion in the direction in which the electric wire bundle 21 extends. For example, the electric wire bundle 21 has the flat portion 25 in a portion of the electric wire bundle 21.

For example, in the flat portion 25, the four electric wires 22 are arranged side by side in a row along one direction perpendicularly intersecting the direction in which the electric wire bundle 21 extends. Note that the direction in which the electric wire bundle 21 extends is hereinafter referred to as an extension direction X. The extension direction X is the length direction of the electric wire bundle 21, and is a direction extending along the center lines L1 of the plurality of electric wires 22 that are bundled. That is, the extension direction X is a direction extending along the length direction of the electric wires 22. In the drawing, the extension direction X is indicated by a double-headed arrow.

In the flat portion 25, a plurality of electric wires 22 are arranged side by side along a first direction Y that perpendicularly intersects the extension direction X. A second direction Z is a direction that perpendicularly intersects the extension direction X and perpendicularly intersects the first direction Y. The first direction Y corresponds to the width direction of the flat portion 25. The second direction Z corresponds to the thickness direction of the flat portion 25. The cross-sectional shape of the flat portion 25 is a flat shape that is long in the first direction Y and thin in the second direction Z. Note that a “transverse cross section” is a cross section cut along a plane perpendicular to the extension direction X. Also, the width of the flat portion 25 in the first direction Y is wider than the width of the flat portion 25 in the second direction Z. In the flat portion 25, the four electric wires 22 extend parallel to each other, for example. Also, in the flat portion 25, the electric wires 22 adjacent to each other in the first direction Y are in contact with each other, for example.

In addition, in this specification, “a plurality of electric wires are arranged side by side in a flat manner” means that a plurality of electric wires are arranged side by side such that the transverse cross-sectional shape of the wire bundle is flat. That is, it means that the electric wires are aligned side by side such that the transverse cross-sectional shape of the electric wire bundle is long in a first direction perpendicularly intersecting the extension direction of the electric wire bundle and thin in the second direction perpendicularly intersecting the first direction. Also, the width of the flat portion in the first direction corresponds to the width of the widest portion in the transverse cross section of the flat portion. Furthermore, the width of the flat portion in the first direction and the width of the flat portion in the second direction are different values, and the width of the flat portion in the first direction is wider than the width of the flat portion in the second direction. Also, in this specification, “flat shape” means a state in which a plurality of electric wires are arranged side by side in a flat manner.

The wire harness 20 includes the exterior member 26 that protects the flat portion 25. The exterior member 26 includes a first tape member 31 and a second tape member 41 that sandwich the flat portion 25 from both sides of the flat portion 25 in the thickness direction. The electric wires 22 in the flat portion 25 are integrally held by, for example, the first tape member 31 and the second tape member 41. Note that the electric wires 22 in the flat portion 25 may also be bundled together by a tape member other than the first tape member 31 and the second tape member 41.

The first tape member 31 is a protective tape member that protects the electric wires 22 from foreign matter that comes into contact with the wire harness 20. The first tape member 31 includes a first base material 32 and a first adhesive layer 33 laminated on one side of the first base material 32.

The first base material 32 is band-shaped. A length direction Ld of the first base material 32 is a direction orthogonal to a width direction Wd of the first base material 32. The first base material 32 has a constant width along the length direction Ld, for example. The first base material 32 has a first surface 34 and a second surface 35 on a side opposite to the first surface 34. The first surface 34 is one of the two surfaces of the first base material 32 in a thickness direction Td of the first base material 32. The second surface 35 is the other of the two surfaces of the first base material 32 in the thickness direction Td.

The first base material 32 has, on the first surface 34, a plurality of protruding portions 36 extending continuously along the width direction Wd. Each protruding portion 36 protrudes in a direction opposite to the second surface 35. Each protruding portion 36 has, for example, a shape obtained by folding the first base material 32 into a mountain fold so as to bulge on the first surface 34 side. The plurality of protruding portions 36 are arranged side by side in the length direction Ld. For example, the plurality of protruding portions 36 are arranged side by side at regular intervals in the length direction Ld.

As the material of the first base material 32, for example, resin materials such as PVC (polyvinyl chloride), PP (polypropylene), and PET (polyethylene terephthalate) can be used.

The first adhesive layer 33 is laminated on the second surface 35. The first adhesive layer 33 is, for example, laminated over the entire second surface 35 in the width direction Wd. Also, the first adhesive layer 33 is laminated, for example, over at least the entire planar portion of the second surface 35 that is perpendicular to the protrusion direction of the protruding portions 36.

The first tape member 31 is affixed to the flat portion 25 by the first adhesive layer 33. The first tape member 31 is arranged on one side of the flat portion 25 in the thickness direction of the flat portion 25. Also, the first tape member 31 is arranged such that, for example, the length direction Ld of the first base material 32 extends along the extension direction X, that is, the length direction of the electric wires 22. For this reason, each protruding portion 36 extends along a direction perpendicular to the length direction of the electric wires 22 in a view from the thickness direction Td of the first base material 32. Also, the first tape member 31 is affixed to at least a portion of the outer peripheral surface of at least one of the electric wires 22 located between the first tape member 31 and the second tape member 41. For example, the first tape member 31 is affixed to a portion of each electric wire 22 in the flat portion 25.

The first tape member 31 may have, at both end regions in the length direction Ld, first adhesion portions 37 at which both end regions of the first base material 32 in the length direction Ld are adhered to the outer peripheral surface of the electric wires 22 by the first adhesive layer 33. Since the first tape member 31 has the first adhesion portions 37, both ends thereof in the length direction Ld are adhered to the outer peripheral surface of the electric wires 22.

The second tape member 41 is, for example, similarly to the first tape member 31, a protective tape member that protects the electric wires 22 from foreign matter that comes into contact with the wire harness 20. The second tape member 41 includes a second base material 42 that is band-shaped and has a first surface 44 and a second surface 45 on a side opposite to the first surface 44, and a second adhesive layer 43 laminated on the second surface 45. The second base material 42 has, on the first surface 44, a plurality of protruding portions 46 extending continuously along the width direction of the second base material 42.

The second tape member 41 is, for example, of the same type as the first tape member 31. In this embodiment, since the first tape member 31 and the second tape member 41 are of the same type, the second base material 42 and the second adhesive layer 43 have the same configuration as the first base material 32 and the first adhesive layer 33. Also, the protruding portions 46 have the same configuration as the protruding portions 36. For this reason, detailed description of the second tape member 41 will be omitted.

The second tape member 41 is affixed to the flat portion 25 by the second adhesive layer 43. The second tape member 41 is arranged on the other side of the flat portion 25 in the thickness direction of the flat portion 25. Also, the second tape member 41 is arranged, for example, such that the length direction of the second base material 42 is along the extension direction X, that is, the length direction of the electric wires 22. For this reason, each protruding portion 46 extends along a direction perpendicular to the length direction of the electric wires 22 in a view from the thickness direction of the second base material 42. Also, the second tape member 41 is affixed to at least a portion of the outer peripheral surface of at least one of the electric wires 22 located between the first tape member 31 and the second tape member 41. For example, the second tape member 41 is affixed to a portion of each electric wire 22 in the flat portion 25.

The second tape member 41 may also include, at both end regions of the second base material 42 in the length direction, second adhesion portions 47 at which both end regions of the second base material 42 in the same length direction are adhered to the outer peripheral surface of the electric wires 22 by the second adhesive layer 43. Since the second tape member 41 has the second adhesion portions 47, both ends of the second tape member 41 in the length direction of the second base material 42 are adhered to the outer peripheral surface of the electric wires 22.

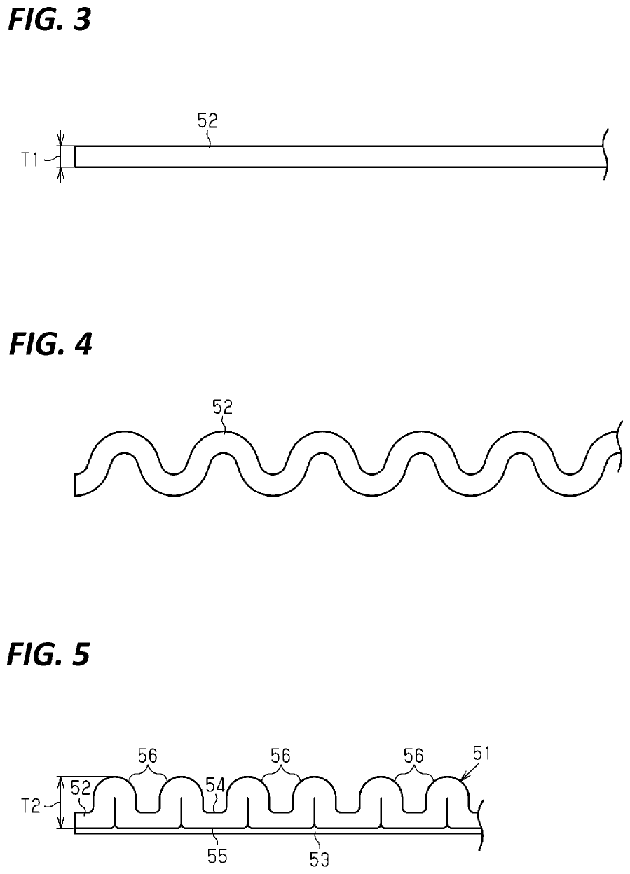

An example of a method for manufacturing the protective tape member 51 used as the first tape member 31 and the second tape member 41 will be described with reference to FIGS. 3 to 6.

As shown in FIG. 3, a long band material 52 that is band-shaped is prepared. FIG. 3 is a side view of the band material 52 viewed from the width direction of the band material 52. The band material 52 becomes the first base material 32 or the second base material 42. For example, the band material 52 has the same width as the first base material 32.

As shown in FIG. 4, a first molding step is performed in which the band material 52 is molded using a mold. For example, the band material 52 is molded using a metal mold so as to have a wavy shape in a view from the width direction of the band material 52. FIG. 4 is a side view of the band material 52 after the first molding step, viewed from the width direction of the band material 52.

Next, as shown in FIG. 5, a second molding step is performed in which the band material 52 formed into a wavy shape in the first molding step is compressed in the length direction to form a plurality of protruding portions 56. In the second molding step, for example, the plurality of protruding portions 56 arranged side by side in the length direction of the band material 52 are formed in the band material 52 using a mold. Also, in the band material 52, a second surface 55 on a side opposite to the first surface 54 from which the protruding portions 56 protrude is formed into a planar shape.

Next, a laminating step of laminating the adhesive layer 53 on the second surface 55 is performed. When the laminating step ends, the protective tape member 51 is complete. FIG. 5 is a side view of the protective tape member 51 viewed from the width direction of the band material 52.

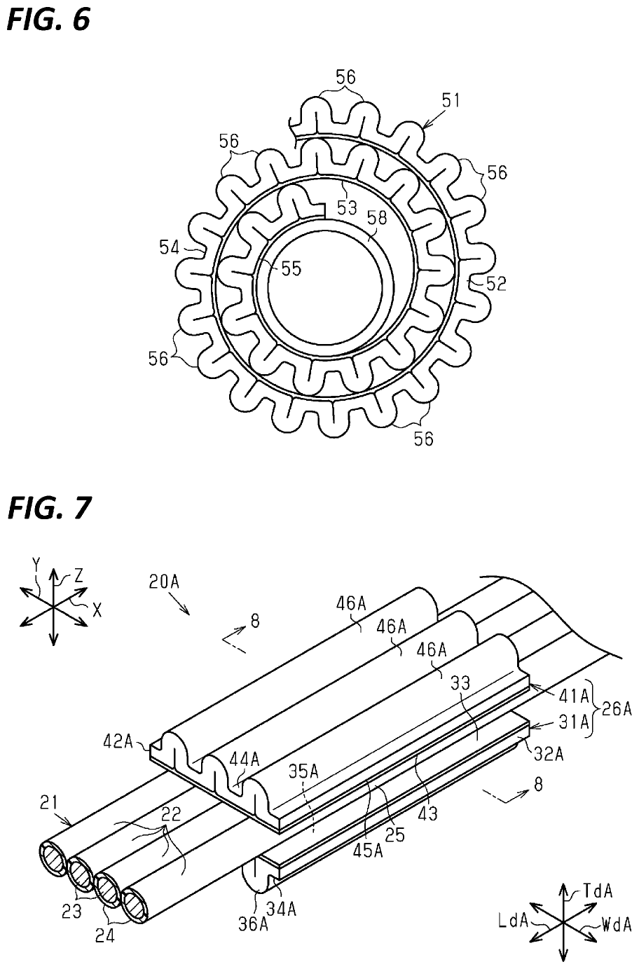

As shown in FIG. 6, the protective tape member 51 can be transported, for example, while spirally wrapped around the outer periphery of a paper tube 58. The first tape member 31 and the second tape member 41 can be formed by cutting the protective tape member 51 wrapped around the paper tube 58 to a desired length.

Note that, as shown in FIGS. 2, 3, and 5, the thickness T1 of the band material 52 prepared to form the protective tape member 51, the maximum thickness T2 of the band material 52 in the protective tape member 51, and the like may be set to desired values according to the wear strength, rigidity, and the like required of the exterior member 26. Incidentally, the maximum thickness T2 of the band material 52 in the protective tape member 51, that is, the base material of the protective tape member 51, is the same as each of the maximum thickness T3 of the first base material 32 in the first tape member 31 and the maximum thickness T4 of the second base material 42 in the second tape member 41.

### Operations and Effects of First Embodiment

The operations and effects of this embodiment will be described.

(1-1) The first tape member 31 and the second tape member 41 are protective tape members that protect the electric wires 22 from foreign matter that comes into contact with the wire harness 20 including at least one electric wire 22. The first tape member 31 includes a first base material 32 that is band-shaped and has a first surface 34 and a second surface 35 on a side opposite to the first surface 34, and a first adhesive layer 33 laminated on the second surface 35. The length direction Ld of the first base material 32 is a direction orthogonal to the width direction Wd of the first base material 32. The first base material 32 has, on the first surface 34, a plurality of protruding portions 36 extending continuously along the width direction Wd. The plurality of protruding portions 36 are arranged side by side in the length direction Ld of the first base material 32. The second tape member 41 includes a second base material 42 that is band-shaped and has a first surface 44 and a second surface 45 on a side opposite to the first surface 44, and a second adhesive layer 43 laminated on the second surface 45. The length direction of the second base material 42 is a direction orthogonal to the width direction of the second base material 42. The second base material 42 has, on the first surface 44, a plurality of protruding portions 46 extending continuously along the width direction of the second base material 42. The plurality of protruding portions 46 are arranged side by side in the length direction of the second base material 42.

According to this configuration, by bringing at least a portion of the first adhesive layer 33 into areal contact with the outer peripheral surface of the electric wires 22, the first tape member 31 can be affixed to the outer peripheral surface of the electric wires 22. By bringing at least a portion of the second adhesive layer 43 into areal contact with the outer peripheral surface of the electric wires 22, the second tape member 41 can be affixed to the outer peripheral surface of the electric wires 22. Also, by affixing the first tape member 31 and the second tape member 41 to the outer peripheral surface of the electric wires 22, the exterior member 26 that protects the electric wires 22 can be formed by the first and second tape members 31 and 41. Also, the plurality of protruding portions 36 can easily increase the maximum thickness of the first tape member 31, and can easily increase the strength of the first tape member 31. Similarly, the plurality of protruding portions 46 can easily increase the maximum thickness of the second tape member 41, and can easily increase the strength of the second tape member 41. Accordingly, by forming the exterior member 26 using the first and second tape members 31 and 41, the exterior member 26 having the same thickness and strength as a corrugated tube can be more easily formed, compared to the case of forming the exterior member using a conventional tape member that does not have a protruding portion.

(1-2) The first tape member 31 has, at both end regions in the length direction Ld, the first adhesion portions 37 at which both end regions of the first base material 32 in the length direction Ld are adhered to the outer peripheral surface of the electric wires 22 by the first adhesive layer 33. The second tape member 41 has, at both end regions of the second base material 42 in the length direction, the second adhesion portions 47 at which both end regions of the second base material 42 in the same length direction are adhered to the outer peripheral surface of the electric wires 22 by the second adhesive layer 43.

According to this configuration, it is possible to suppress peeling of the first tape member 31 and the second tape member 41 from the outer peripheral surface of the electric wires 22.

(1-3) The wire harness 20 includes the electric wire bundle 21 including the plurality of electric wires 22. The electric wire bundle 21 has a flat portion 25 in which the plurality of electric wires 22 are arranged side by side in a flat manner in at least a portion in the direction in which the electric wire bundle 21 extends. The wire harness 20 includes the exterior member 26 that protects the flat portion 25. The exterior member 26 includes the first tape member 31 and the second tape member 41 that sandwich the flat portion 25 from both sides of the flat portion 25 in the thickness direction. The first tape member 31 is a protective tape member that is affixed to the flat portion 25 by the first adhesive layer 33. The second tape member 41 is a protective tape member that is affixed to the flat portion 25 by the second adhesive layer 43.

According to this configuration, the first tape member 31 and the second tape member 41 can be affixed to the flat portion 25 by the first adhesive layer 33 and the second adhesive layer 43, respectively. For this reason, each of the first tape member 31 and the second tape member 41 can be easily arranged with respect to the flat portion 25. That is, the exterior member 26 can be easily attached to the electric wires 22.

(1-4) A case will be considered in which an exterior member having the same strength as the exterior member 26 is formed using a conventional tape member that has a constant thickness and does not include a protruding portion. In this case, in order to ensure the strength of the exterior member, for example, it is conceivable that the conventional tape member is wrapped around the outer periphery of the electric wires such that the thickness of the exterior member formed by the conventional tape member reaches a thickness equal to the maximum thickness of the first tape member 31 or the second tape member 41. However, in this case, the exterior member formed by the conventional tape member becomes larger in mass than the exterior member 26 formed by the first tape member 31 and the second tape member 41. That is, the exterior member 26 formed by the first tape member 31 and the second tape member 41 can have a smaller mass and the same strength as the exterior member formed using the conventional tape member. Accordingly, the manufacturing cost for the exterior member 26 can be reduced compared to the case of forming the exterior member using a conventional tape member.

Also, a case will be considered in which a conventional tape member having a constant thickness and not having a protruding portion is arranged with respect to electric wires in the same manner as the first tape member 31 and the second tape member 41 to form an exterior member. In this case, the exterior member is thinner than the exterior member 26. That is, the exterior member 26 formed by the first tape member 31 and the second tape member 41 is thicker than the exterior member formed by arranging the conventional tape member in the same manner as the first tape member 31 and the second tape member 41. Accordingly, the wear resistance of the exterior member 26 can be improved compared to that of the exterior member.

(1-5) In this embodiment, the first tape member 31 and the second tape member 41 are protective tape members having the same configuration. For this reason, by preparing one type of protective tape member 51, both the first tape member 31 and the second tape member 41 can be prepared. Accordingly, preparation of the protective tape member constituting the exterior member 26 is easier compared to the case where the first tape member 31 and the second tape member 41 are protective tape members having different configurations. Also, since it is sufficient to manufacture one type of protective tape member, the manufacturing cost for the exterior member 26 can be reduced compared to the case where two types of protective tape members, namely one for the first tape member 31 and one for the second tape member 41, are manufactured.

(1-6) In the wire harness 20, each protruding portion 36 of the first tape member 31 and each protruding portion 46 of the second tape member 41 extend along a direction perpendicular to the length direction of the electric wires 22 in a view from the thickness direction Td. For this reason, the electric wires 22 at the portion to which the exterior member 26 is attached are easily bent in the thickness direction Td.

### Second Embodiment

A second embodiment of the exterior member and the wire harness will be described below. Note that in the second embodiment, configurations that are the same as or correspond to those in the first embodiment are denoted by the same reference numerals, and some or all of the description of those configurations is omitted.

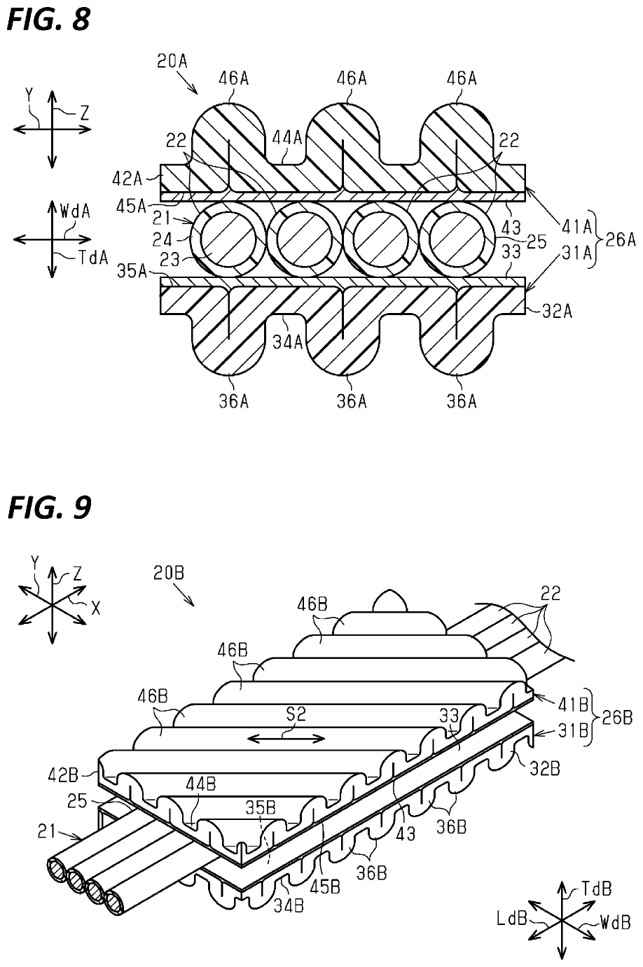

As shown in FIGS. 7 and 8, the wire harness 20A of the second embodiment is configured to include an exterior member 26A that protects the flat portion 25 instead of the exterior member 26 in the wire harness 20 of the first embodiment. Note that FIG. 8 is a cross-sectional view taken along line 8-8 in FIG. 7.

The exterior member 26A includes a first tape member 31A and a second tape member 41A that sandwich the flat portion 25 from both sides of the flat portion 25 in the thickness direction. The electric wires 22 in the flat portion 25 are integrally held by, for example, the first tape member 31A and the second tape member 41A.

The first tape member 31A is a protective tape member that protects the electric wires 22 from foreign matter that comes into contact with the wire harness 20A. The first tape member 31A includes a first base material 32A and a first adhesive layer 33 laminated on one side of the first base material 32A.

The first base material 32A is band-shaped. A length direction LdA of the first base material 32A is a direction orthogonal to a width direction WdA of the first base material 32A. The first base material 32A has a constant width along the length direction LdA, for example. The first base material 32A has a first surface 34A and a second surface 35A on a side opposite to the first surface 34A. One of the two surfaces of the first base material 32A in a thickness direction TdA of the first base material 32A is the first surface 34A, and the other surface is the second surface 35A.

The first base material 32A has a plurality of protruding portions 36A extending continuously along the length direction LdA on the first surface 34A. The first base material 32A has, for example, three protruding portions 36A. Each protruding portion 36A protrudes in a direction opposite to the second surface 35A. Each protruding portion 36A has, for example, a shape obtained by folding the first base material 32A into a mountain fold so as to bulge on the first surface 34A side. The plurality of protruding portions 36A are arranged side by side in the width direction WdA. For example, the plurality of protruding portions 36A are arranged at regular intervals in the width direction WdA. As the material of the first base material 32A, the same resin material as the first base material 32 of the first embodiment can be used.

The first adhesive layer 33 is laminated on the second surface 35A. The first adhesive layer 33 is laminated, for example, over the entire second surface 35A in the width direction WdA. Also, the first adhesive layer 33 is laminated, for example, over at least the entire planar portion of the second surface 35A that is perpendicular to the protrusion direction of the protruding portions 36A.

The first tape member 31A is affixed to the flat portion 25 by the first adhesive layer 33. The first tape member 31A is arranged on one side of the flat portion 25 in the thickness direction of the flat portion 25. Also, the first tape member 31A is arranged such that, for example, the length direction LdA of the first base material 32A is along the extension direction X, that is, the length direction of the electric wires 22. For this reason, each protruding portion 36A extends along the length direction of the electric wires 22 in a view from the thickness direction TdA. Also, the first tape member 31A is affixed to at least a portion of the outer peripheral surface of at least one of the electric wires 22 located between the first tape member 31A and the second tape member 41A. For example, the first tape member 31A is affixed to a portion of each electric wire 22 in the flat portion 25.

The second tape member 41A is, for example, a protective tape member that protects the electric wires 22 from foreign matter that comes into contact with the wire harness 20A, similarly to the first tape member 31A. The second tape member 41A includes a second base material 42A that is band-shaped and has a first surface 44A and a second surface 45A on a side opposite to the first surface 44A, and a second adhesive layer 43 laminated on the second surface 45A. The second base material 42A has, on the first surface 44A, a plurality of protruding portions 46A extending continuously along the length direction of the second base material 42A.

The second tape member 41A is, for example, of the same type as the first tape member 31A. In this embodiment, since the first tape member 31A and the second tape member 41A are of the same type, the second base material 42A and the second adhesive layer 43 have the same configuration as the first base material 32A and the first adhesive layer 33. Also, the protruding portions 46A have the same configuration as the protruding portions 36A.

The second tape member 41A is affixed to the flat portion 25 by the second adhesive layer 43. The second tape member 41A is arranged on the other side of the flat portion 25 in the thickness direction of the flat portion 25. Also, the second tape member 41A is arranged, for example, such that the length direction of the second base material 42A is along the extension direction X, that is, the length direction of the electric wires 22. For this reason, each convex portion 46A extends along the length direction of the electric wires 22 in a view from the thickness direction of the second base material 42A. Also, the second tape member 41A is affixed to at least a portion of the outer peripheral surface of at least one of the electric wires 22 located between the first tape member 31A and the second tape member 41A. For example, the second tape member 41A is affixed to a portion of each electric wire 22 in the flat portion 25.

### Operations and Effects of Second Embodiment

According to this embodiment, in addition to the same effects as (1-4) and (1-5) of the first embodiment, the following effects are achieved.

(2-1) The first tape member 31A and the second tape member 41A are protective tape members that protect the electric wires 22 from foreign matter that comes into contact with the wire harness 20A including at least one electric wire 22. The first tape member 31A includes a first base material 32A that is band-shaped and has a first surface 34A and a second surface 35A on a side opposite to the first surface 34A, and a first adhesive layer 33 laminated on the second surface 35A. The length direction LdA of the first base material 32A is a direction orthogonal to the width direction WdA of the first base material 32A. The first base material 32A has, on the first surface 34A, a plurality of protruding portions 36A extending continuously along the length direction LdA. The plurality of protruding portions 36A are arranged side by side in the width direction WdA of the first base material 32A. The second tape member 41A includes a second base material 42A that is band-shaped and has a first surface 44A and a second surface 45A on a side opposite to the first surface 44A, and a second adhesive layer 43 laminated on the second surface 45A. The length direction of the second base material 42A is a direction orthogonal to the width direction of the second base material 42A. The second base material 42A has, on the first surface 44A, a plurality of protruding portions 46A extending continuously along the length direction of the second base material 42A. The plurality of protruding portions 46A are arranged side by side in the width direction of the second base material 42A.

According to this configuration, by bringing at least a portion of the first adhesive layer 33 into areal contact with the outer peripheral surface of the electric wires 22, the first tape member 31A can be affixed to the outer peripheral surface of the electric wires 22. By bringing at least a portion of the second adhesive layer 43 into areal contact with the outer peripheral surface of the electric wires 22, the second tape member 41A can be affixed to the outer peripheral surface of the electric wires 22. Also, by affixing the first tape member 31A and the second tape member 41A to the outer peripheral surface of the electric wires 22, an exterior member 26A that protects the electric wires 22 can be formed by the first and second tape members 31A and 41A. Also, the plurality of protruding portions 36A can easily increase the maximum thickness of the first tape member 31A, and can easily increase the strength of the first tape member 31A. Similarly, the plurality of protruding portions 46A can easily increase the maximum thickness of the second tape member 41A, and can easily increase the strength of the second tape member 41A. Accordingly, by forming the exterior member 26A with the first and second tape members 31A and 41A, the exterior member 26A with the same thickness and strength as a corrugated tube can be more easily formed, compared to the case of forming the exterior member by a conventional tape member that does not have a protruding portion.

(2-2) The wire harness 20A includes an electric wire bundle 21 including a plurality of electric wires 22. The electric wire bundle 21 has a flat portion 25 in which the plurality of electric wires 22 are arranged side by side in a flat manner in at least a portion in the direction in which the electric wire bundle 21 extends. The wire harness 20A includes an exterior member 26A that protects the flat portion 25. The exterior member 26A includes the first tape member 31A and the second tape member 41A that sandwich the flat portion 25 from both sides of the flat portion 25 in the thickness direction. The first tape member 31A is a protective tape member that is affixed to the flat portion 25 by the first adhesive layer 33. The second tape member 41A is a protective tape member that is affixed to the flat portion 25 by the second adhesive layer 43.

According to this configuration, each of the first tape member 31A and the second tape member 41A is a protective tape member whose maximum thickness is increased and whose strength is increased by the plurality of protruding portions 36A or the plurality of protruding portions 46A. Accordingly, the exterior member 26A formed by the first tape member 31A and the second tape member 41A can more easily be provided with the same thickness and strength as a corrugated tube, compared to an exterior member formed by a conventional tape member that does not have a protruding portion. Also, the first tape member 31A and the second tape member 41A can be affixed to the flat portion 25 by the first adhesive layer 33 and the second adhesive layer 43, respectively. For this reason, each of the first tape member 31A and the second tape member 41A can be easily arranged with respect to the flat portion 25. That is, the exterior member 26A can be easily attached to the electric wires 22.

(2-3) In the wire harness 20A, each protruding portion 36A of the first tape member 31A and each protruding portion 46A of the second tape member 41A extend along the length direction of the electric wires 22. For this reason, bending of the electric wires 22 at the portion where the exterior member 26A is attached can be suppressed.

### Third Embodiment

A third embodiment of the exterior member and the wire harness will be described hereinafter. Note that in the third embodiment, configurations that are the same as or correspond to those in the first embodiment are denoted by the same reference numerals, and some or all of the description of the configurations is omitted.

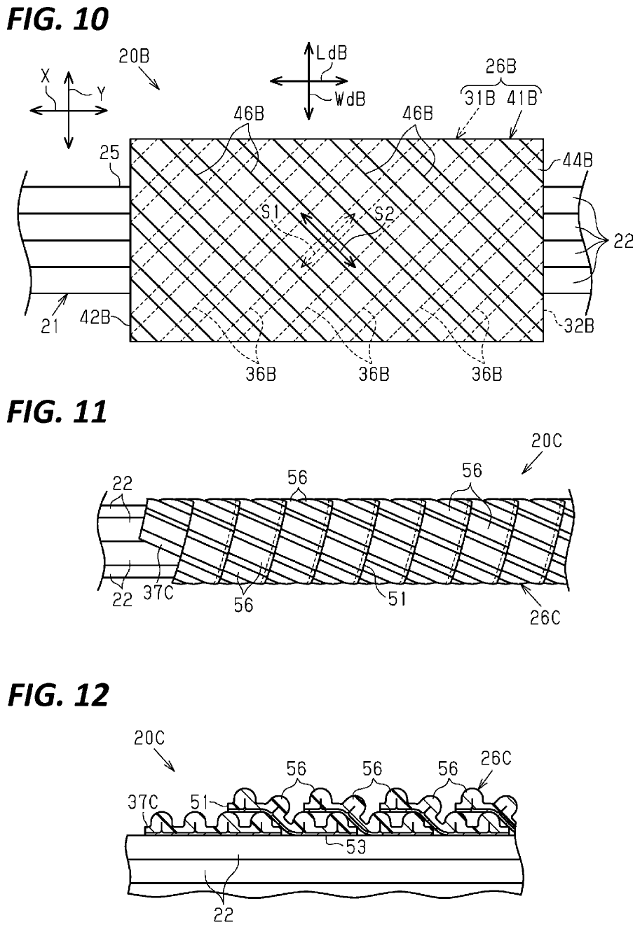

As shown in FIGS. 9 and 10, the wire harness 20B of the third embodiment is configured to include an exterior member 26B that protects the flat portion 25 instead of the exterior member 26 in the wire harness 20 of the above-described first embodiment. Note that FIG. 10 is a plan view of the wire harness 20B viewed from the thickness direction of the flat portion 25.

The exterior member 26B includes a first tape member 31B and a second tape member 41B that sandwich the flat portion 25 from both sides of the flat portion 25 in the thickness direction. The electric wires 22 in the flat portion 25 are integrally held by, for example, the first tape member 31B and the second tape member 41B.

The first tape member 31B is a protective tape member that protects the electric wires 22 from foreign matter that comes into contact with the wire harness 20B. The first tape member 31B includes a first base material 32B and a first adhesive layer 33 laminated on one side of the first base material 32B.

The first base material 32B is band-shaped. A length direction LdB of the first base material 32B is a direction orthogonal to a width direction WdB of the first base material 32A. The first base material 32B has a constant width along the length direction LdB, for example. The first base material 32B has a first surface 34B and a second surface 35B on a side opposite to the first surface 34B. One of the two surfaces of the first base material 32B in a thickness direction TdB of the first base material 32A is the first surface 34B and the other surface is the second surface 35B.

The first base material 32B has, on the first surface 34B, a plurality of protruding portions 36B extending continuously along a reference direction S1 that intersects the width direction WdB and the length direction LdB in a view from the thickness direction TdB. Each protruding portion 36B protrudes in a direction opposite to the second surface 35B. Each protruding portion 36B has, for example, a shape obtained by folding the first base material 32B into mountain folds so as to bulge on the first surface 34B side. The plurality of protruding portions 36B are arranged side by side in the length direction LdB. For example, the plurality of protruding portions 36B are arranged side by side at regular intervals in the length direction LdB. As the material of the first base material 32B, the same resin material as the first base material 32 of the first embodiment can be used.

The first adhesive layer 33 is laminated on the second surface 35B. The first adhesive layer 33 is, for example, laminated over the entire second surface 35B in the width direction WdB. Also, the first adhesive layer 33 is laminated, for example, over at least the entire planar portion of the second surface 35B that is perpendicular to the protrusion direction of the protruding portions 36B.

The first tape member 31B is affixed to the flat portion 25 by the first adhesive layer 33. The first tape member 31B is arranged on one side of the flat portion 25 in the thickness direction of the flat portion 25. Also, the first tape member 31B is arranged such that, for example, the length direction LdB of the first base material 32B is along the extension direction X, that is, the length direction of the electric wires 22. For this reason, each protruding portion 36B extends along a direction intersecting the length direction of the electric wires 22 in a view from the thickness direction TdB. Then, the first tape member 31B is affixed to at least a portion of the outer peripheral surface of at least one of the electric wires 22 located between the first tape member 31B and the second tape member 41B. For example, the first tape member 31B is affixed to a portion of each electric wire 22 in the flat portion 25.

The second tape member 41B is, for example, a protective tape member that protects the electric wires 22 from foreign matter that comes into contact with the wire harness 20B, similarly to the first tape member 31B. The second tape member 41B includes a second base material 42B that is band-shaped and has a first surface 44B and a second surface 45B on a side opposite to the first surface 44B, and a second adhesive layer 43 laminated on the second surface 45B. The second base material 42B has, on the first surface 44B, a plurality of protruding portions 46B extending continuously along a reference direction S2 that intersects the width direction of the second base material 42B and intersects the length direction of the second base material 42B in a view from the thickness direction of the second base material 42B.

The second tape member 41B is, for example, of the same type as the first tape member 31B. In this embodiment, since the first tape member 31B and the second tape member 41B are of the same type, the second base material 42B and the second adhesive layer 43 have the same configuration as the first base material 32B and the first adhesive layer 33. Also, the protruding portions 46B have the same configuration as the protruding portions 36B.

The second tape member 41B is affixed to the flat portion 25 by the second adhesive layer 43. The second tape member 41B is arranged on the other side of the flat portion 25 in the thickness direction of the flat portion 25. Also, the second tape member 41B is arranged, for example, such that the length direction of the second base material 42A is along the extension direction X, that is, the length direction of the electric wires 22. Furthermore, the second tape member 41B may also be arranged such that the direction in which the protruding portions 36B extend (i.e., the reference direction S1) and the direction in which the protruding portions 46B extend (i.e., the reference direction S2) intersect each other in a view from the thickness direction TdB of the wire harness 20B. For this reason, each protruding portion 46B extends along a direction intersecting the length direction of the electric wires 22 and intersects the protruding portions 36B, in a view from the thickness direction TdB. Then, the second tape member 41B is affixed to at least a portion of the outer peripheral surface of at least one of the electric wires 22 located between the first tape member 31B and the second tape member 41B. For example, the second tape member 41B is affixed to a portion of each electric wire 22 in the flat portion 25.

### Operations and Effects of Third Embodiment

According to this embodiment, in addition to the same operations and effects as (1-4) and (1-5) of the first embodiment, the following effects are achieved.

(3-1) The first tape member 31B and the second tape member 41B are protective tape members that protect the electric wire 22 from foreign matter that comes into contact with the wire harness 20B including at least one electric wire 22. The first tape member 31B includes a first base material 32B that is band-shaped and has a first surface 34B and a second surface 35B on a side opposite to the first surface 34B, and a first adhesive layer 33 laminated on the second surface 35B. The length direction LdB of the first base material 32B is a direction orthogonal to the width direction WdB of the first base material 32B. The first base material 32B has, on the first surface 34B, a plurality of protruding portions 36B extending continuously along a reference direction S1 that intersects the width direction WdB and the length direction LdB in a view from the thickness direction TdB. The plurality of protruding portions 36B are arranged side by side in the length direction LdB. The second tape member 41B includes a second base material 42B that is band-shaped and has a first surface 44B and a second surface 45B on a side opposite to the first surface 44B, and a second adhesive layer 43 laminated on the second surface 45B. The length direction of the second base material 42B is a direction orthogonal to the width direction of the second base material 42B. The second base material 42B includes, on the first surface 44B, a plurality of protruding portions 46B extending continuously along a reference direction S2 that intersects the width direction of the second base material 42 and intersects the length direction of the second base material 42 in a view from the thickness direction of the second base material 42. The plurality of protruding portions 46B are arranged side by side in the length direction of the second base material 42B.

According to this configuration, by bringing at least a portion of the first adhesive layer 33 into areal contact with the outer peripheral surface of the electric wires 22, the first tape member 31B can be affixed to the outer peripheral surface of the electric wires 22. By bringing at least a portion of the second adhesive layer 43 into areal contact with the outer peripheral surface of the electric wires 22, the second tape member 41B can be affixed to the outer peripheral surface of the electric wires 22. Then, by affixing the first tape member 31B and the second tape member 41B to the outer peripheral surface of the electric wires 22, an exterior member 26B that protects the electric wires 22 can be formed by the first and second tape members 31B and 41B. Also, the plurality of protruding portions 36B can easily increase the maximum thickness of the first tape member 31B, and can easily increase the strength of the first tape member 31B. Similarly, the plurality of protruding portions 46B can easily increase the maximum thickness of the second tape member 41B, and can easily increase the strength of the second tape member 41B. Accordingly, by forming the exterior member 26B with the first and second tape members 31B and 41B, the exterior member 26B with the same thickness and strength as a corrugated tube can be more easily formed, compared to the case of forming the exterior member by a conventional tape member that does not have a protruding portion.

(3-2) The wire harness 20B includes an electric wire bundle 21 having a plurality of electric wires 22. The electric wire bundle 21 has a flat portion 25 in which the plurality of electric wires 22 are arranged side by side in a flat manner in at least a portion in the direction in which the electric wire bundle 21 extends. The wire harness 20B includes an exterior member 26B that protects the flat portion 25. The exterior member 26B includes a first tape member 31B and a second tape member 41B that sandwich the flat portion 25 from both sides of the flat portion 25 in the thickness direction. The first tape member 31B is a protective tape member that is affixed to the flat portion 25 by the first adhesive layer 33. The second tape member 41B is a protective tape member that is affixed to the flat portion 25 by the second adhesive layer 43.

According to this configuration, each of the first tape member 31B and the second tape member 41B is a protective tape member whose maximum thickness is increased and whose strength is increased by the plurality of protruding portions 36B or the plurality of protruding portions 46B. Accordingly, the exterior member 26B formed by the first tape member 31B and the second tape member 41B can easily be provided with the same thickness and strength as a corrugated tube, compared to an exterior member formed by a conventional tape member without a protruding portion. Also, the first tape member 31B and the second tape member 41B can be affixed to the flat portion 25 by the first adhesive layer 33 and the second adhesive layer 43, respectively. For this reason, each of the first tape member 31B and the second tape member 41B can be easily arranged with respect to the flat portion 25. That is, the exterior member 26B can be easily attached to the electric wires 22.

(3-3) The second tape member 41B is arranged such that the plurality of protruding portions 46B intersect the plurality of protruding portions 36B in a view from the thickness direction TdB. For this reason, it is possible to further suppress bending of the electric wires 22 at the portion where the exterior member 26B is attached, compared to the case where the second tape member 41B is arranged such that the direction in which each protruding portion 46B extends is along the direction in which each protruding portion 36B extends in a view from the thickness direction TdB.

Each embodiment can be implemented with the following modifications. Each embodiment and the following modified examples can be implemented in combination with each other within a range in which there is no technical discrepancy. Note that in the modified examples described below, configurations that are the same as or correspond to the above-described embodiments are denoted by the same reference numerals, and some or all of the description of the configurations is omitted.
In the above-described first embodiment, the first tape member 31 does not need to have the first adhesion portion 37. Similarly, the second tape member 41 does not need to have the second adhesion portion 47.
In the above-described third embodiment, the second tape member 41B is arranged such that the plurality of protruding portions 46B intersect with the plurality of protruding portions 36B in a view from the thickness direction TdB. However, the second tape member 41B may also be arranged such that the direction in which each protruding portion 46B extends is along the direction in which each protruding portion 36B extends in a view from the thickness direction TdB. That is, the second tape member 41 may also be arranged such that the reference direction S2 and the reference direction S1 are parallel to each other.
A wire harness 20C illustrated in FIGS. 11 and 12 includes at least one electric wire 22 and an exterior member 26C formed by the protective tape member 51 of the above-described first embodiment. Note that in FIG. 12, the exterior member 26C is illustrated as an end surface diagram taken along the length direction of the electric wires 22. The wire harness 20C includes, for example, a plurality of electric wires 22. The protective tape member 51 is spirally wrapped around the outer periphery of the electric wires 22 such that portions of the protective tape member 51 in the width direction overlap. Note that the protective tape member 51 may also have adhesion portions 37C similar to the first adhesion portions 37 of the first embodiment described above, at the end portion regions in the length direction of the protective tape member 51.

In this way, with the adhesive layer 53 of the later-wrapped protective tape member 51, a portion of the previously-wrapped protective tape member 51 in the width direction adheres a portion of the later-wrapped protective tape member 51 in the width direction. Accordingly, the spirally-wrapped protective tape member 51 forms a cylinder surrounding the outer periphery of the electric wires 22. The cylinder formed by the protective tape member 51 can protect the electric wires 22 from foreign matter that comes into contact with the wire harness 20C. In this way, by spirally wrapping the protective tape member 51 around the outer periphery of the electric wires 22, the exterior member 26C having the same thickness and strength as a corrugated tube can be easily formed.

Also, since the protective tape member 51 can be affixed to the outer peripheral surface of the electric wires 22 using the adhesive layer 53, it is not necessary to perform a step of fixing the exterior member 26C formed by the protective tape member 51 to the electric wires 22 using a separate fixing tape member or the like. Accordingly, there is no need to perform a step of fixing a corrugated tube to the electric wires with a tape member or a step of wrapping the tape member around the outer periphery of the corrugated tube, which are performed when a corrugated tube is used as the exterior member. That is, the number of work steps can be reduced compared to the case where a corrugated tube is used as the exterior member. Accordingly, the exterior member 26C can be easily attached to the electric wires 22.

Note that the protective tape member used as the first tape member 31B or the second tape member 41B in the third embodiment may also be spirally wrapped around the outer periphery of the electric wires 22 as the exterior member 26C. Even in this case, the same effect as the example shown in FIG. 11 can be achieved.

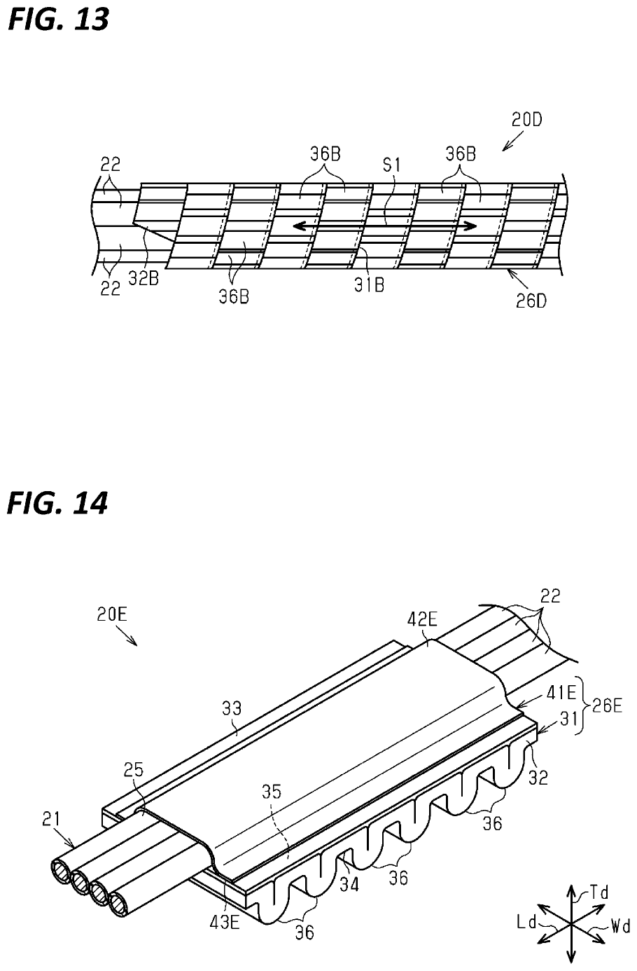

For example, the wire harness 20D illustrated in FIG. 13 includes at least one electric wire 22 and an exterior member 26D formed by the first tape member 31B (protective tape member) of the third embodiment. The first tape member 31B is spirally wrapped around the outer periphery of the electric wires 22 such that portions in the width direction of the first tape member 31B overlap. In the exterior member 26D, each of the plurality of protruding portions 36B extends along the length direction of the electric wires 22 on the outer periphery of the electric wires 22, for example. That is, the inclination angle of each protruding portion 36B with respect to the length direction LdB and width direction WdB of the first base material 32B is set to an angle according to which each protruding portion 36B can extend along the length direction of the electric wires 22 when the first tape member 31B is spirally wrapped around the outer periphery of the electric wires 22. In other words, the reference direction S1 is set in a direction along the length direction of the electric wires 22 when the first tape member 31B is spirally wrapped around the outer periphery of the electric wires 22. In this way, the shape of the electric wires 22 can be easily maintained in a linear shape while providing rigidity using the exterior member 26D in the portion where the electric wires 22 are to be maintained in a linear shape. Accordingly, it is possible to suppress bending of the wire harness 20D in the portion where the wire harness 20D is to be maintained in a linear shape.
In the wire harness 20 of the above-described first embodiment, either one of the first tape member 31 and the second tape member 41 may be replaced with a common existing tape member used for bundling electric wires 22. Similar changes may also be made in the second embodiment and the third embodiment.

For example, a wire harness 20E illustrated in FIG. 14 includes an exterior member 26E that protects the flat portion 25. The exterior member 26E includes a first tape member 31 and a second tape member 41E that are affixed to each other from both sides of the flat portion 25 in the thickness direction with the flat portion 25 interposed therebetween. The first tape member 31 is of the first embodiment described above. The second tape member 41E includes a second base material 42E that is band-shaped and thinner than the first base material 32, and a second adhesive layer 43E laminated on one side of the second base material 42E. The second tape member 41E is an existing tape member commonly used for bundling the electric wires 22. As the second tape member 41E, for example, a commercially-available PVC tape or the like can be used. The second base material 42E does not have a protruding portion such as the protruding portions 36. Furthermore, the second base material 42E has, for example, a uniform thickness. The second tape member 41E is affixed to the flat portion 25 by the second adhesive layer 43E. The first tape member 31 and the second tape member 41E may also be directly affixed to each other on both sides of the flat portion 25 in the width direction, for example.

In this way, while using the first tape member 31 and the second tape member 41E, which are the protective tape members 51, the first tape member 31 can protect the flat portion 25 due to the first tape member 31 being arranged on the side that may come into contact with foreign matter out of the two sides in the thickness direction of the flat portion 25. In this case, by using a tape member conventionally generally used for bundling electric wires 22 as the second tape member 41E, the manufacturing cost for the exterior member 26E can be further reduced.

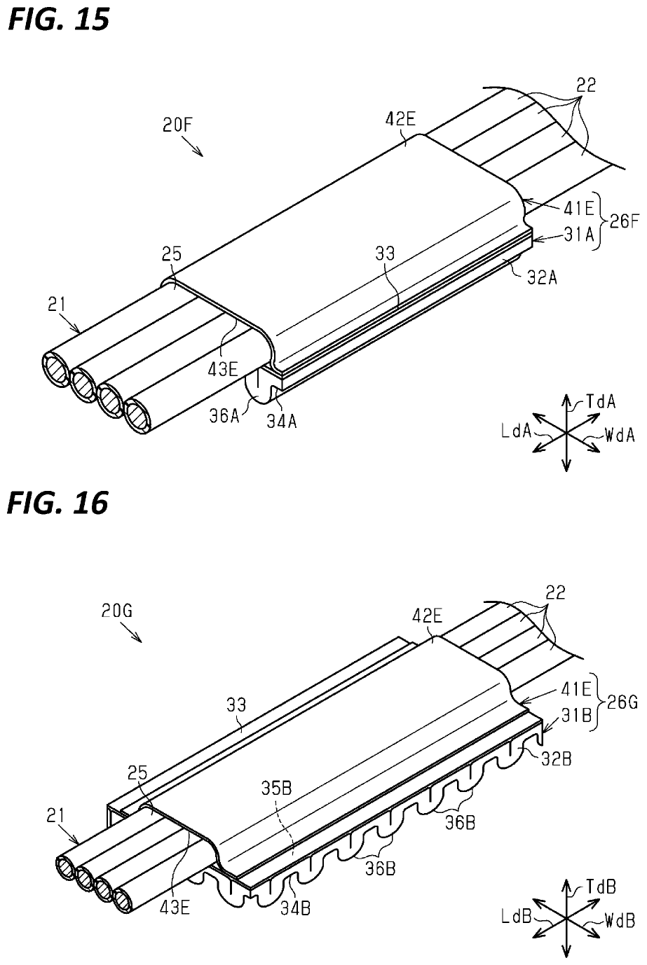

Also, for example, a wire harness 20F illustrated in FIG. 15 includes an exterior member 26F that protects the flat portion 25. The exterior member 26F includes a first tape member 31A and a second tape member 41E that are affixed to each other from both sides of the flat portion 25 in the thickness direction with the flat portion 25 interposed therebetween. The first tape member 31A is of the second embodiment described above. The first tape member 31A and the second tape member 41E may also be directly affixed to each other on both sides of the flat portion 25 in the width direction, for example. Even in this case, the same effect as the example shown in FIG. 14 can be achieved.

Also, for example, a wire harness 20G illustrated in FIG. 16 includes an exterior member 26G that protects the flat portion 25. The exterior member 26F includes a first tape member 31B and a second tape member 41E that are affixed to each other from both sides of the flat portion 25 with the flat portion 25 interposed therebetween. The first tape member 31B is of the third embodiment described above. The first tape member 31B and the second tape member 41E may also be directly affixed to each other on both sides of the flat portion 25 in the width direction, for example. Even in this case, the same effect as the example shown in FIG. 14 can be achieved.
The end portion regions of the first tape member 31A and the second tape member 41A in the width direction WdA of the second embodiment may also be directly affixed to each other.

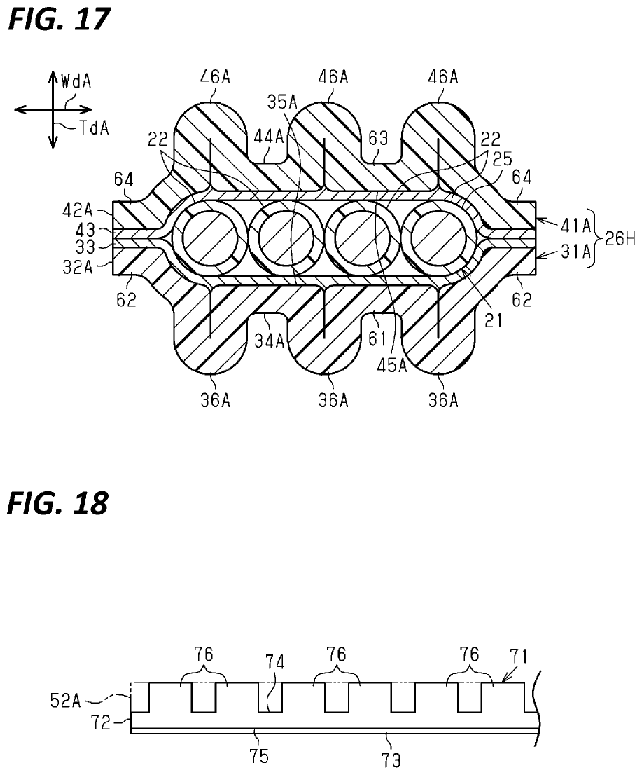

For example, as shown in FIG. 17, an exterior member 26H may also be constituted by two tape members, that is, the first tape member 31A and the second tape member 41A, which are affixed to each other while sandwiching the electric wires 22 from both sides in a direction orthogonal to the length direction of the electric wires 22.

The first tape member 31A has an accommodation portion 61 and end portion affixing portions 62. The accommodation portion 61 is a portion of the first tape member 31A that is recessed in the direction from the second surface 35A toward the first surface 34A and extends in the length direction LdA. For example, the accommodation portion 61 is located at the center of the first tape member 31A in the width direction WdA. A portion of the electric wires 22 in the length direction is arranged inside the accommodation portion 61. The end portion affixing portions 62 are located on both sides of the accommodation portion 61 in the width direction WdA in the first tape member 31A. The end portion affixing portions 62 are affixed to the partner-side second tape member 41A by the first adhesive layer 33. The first tape member 31A has, for example, end portion affixing portions 62 at both end regions of the first tape member 31A in the width direction WdA.

The second tape member 41A has, for example, the same shape as the first tape member 31A. That is, the second tape member 41 has an accommodation portion 63 having the same shape as the accommodation portion 61, and end portion affixing portions 64 having the same shape as the end portion affixing portions 62. The end portion affixing portions 64 are located on both sides of the accommodation portion 63 in the width direction WdA, and are affixed to the partner-side first tape member 31A by the second adhesive layer 43.

The first tape member 31A and the second tape member 41A are affixed to each other such that the electric wires 22 are accommodated inside the accommodation portions 61 and 63, and such that the end portion affixing portions 62 and 64 are affixed to each other. When the first tape member 31A and the second tape member 41A are affixed to each other, the accommodation portion 61 and the accommodation portion 63 form a cylinder through which the electric wires 22 pass.

In this way, the second tape member 41A can be affixed to the end portion affixing portions 62 of the first tape member 31A. Also, the first tape member 31A can be affixed to the end portion affixing portions 64 of the second tape member 41A. For this reason, it is easier to affix the first tape member 31A and the second tape member 41A that constitute the exterior member 26H to each other. Also, at least a portion of the electric wires 22 in the length direction of the electric wires 22 can be easily surrounded over the entire periphery by the first tape member 31A and the second tape member 41A.

Note that in this example, by changing the depths of the accommodation portions 61 and 63, the exterior member 26H can be attached also to a portion of the electric wire bundle 21 other than the flat portion 25, that is, a portion where the electric wires 22 are not bundled in a flat shape.

Also, in the exterior member 26H, the second tape member 41A may be changed to any one of the second tape member 41 of the above-described first embodiment, the second tape member 41A of the above-described second embodiment that does not include the accommodation portion 63 and the end portion affixing portion 64, and the second tape member 41B of the above-described third embodiment. In this case, it is preferable to change the depth of the accommodation portion 63 to a depth at which at least a portion of the electric wires 22 in the length direction of the electric wires 22 can be accommodated.

Also, for example, the first tape member 31 of the first embodiment may have the accommodation portion 61 and the end portion affixing portions 62. Similarly, the second tape member 41 of the above-described first embodiment may also have the accommodation portion 63 and the end portion affixing portions 64. Similar changes may also be made to the first tape member 31B and the second tape member 41B of the above-described third embodiment.

Incidentally, the wire harness 20F illustrated in FIG. 15 may also include the first tape member 31A having the accommodation portion 61 and the end portion affixing portion 62 illustrated in FIG. 17 instead of the first tape member 31A.
In the first embodiment described above, the method for forming the protruding portions 36 is not limited to the method of the above embodiment.

For example, a protective tape member 71 shown in FIG. 18 has a base material 72. An adhesive layer 73 is laminated on a second surface 75 of the base material 72. The base material 72 has a plurality of protruding portions 76 extending in the width direction of the base material 72 on the first surface 74. The base material 72 is formed by processing a band material 52A that has a uniform thickness and is band-shaped. In FIG. 18, the outer shape of the band material 52A is illustrated with a two-dot chain line. By partially scraping off the band material 52A, a base material 72 having a plurality of protruding portions 76 is formed. Note that the two-dot chain line shown in FIG. 18 represents the outer shape of the band material 52A before being partially scraped off. In the example shown in FIG. 18, the protruding portions 76 have a rectangular cross section perpendicular to the direction in which the protruding portions 76 extends. However, the cross-sectional shape of the protruding portions 76 may be a polygonal shape other than a quadrangular shape, a semicircular shape, or any other shape. Note that if the corners of the tips of the protruding portions 76 are rounded, it is possible to suppress the protruding portions 76 from cracking, compared to a case where the corners of the tips of the protruding portions 76 are sharp. Also, when the base ends of the protruding portions 76 are connected to the portions between adjacent protruding portions 76 on the base material 72 through arc-shaped surfaces, the breakage resistance near the base ends of the protruding portions 76 can be improved.

Also, the base material 72 having the protruding portions 76 may be formed by, for example, injection molding.
In the exterior member 26 of the above-described first embodiment, the second tape member 41 may also be replaced with the second tape member 41A of the above-described second embodiment or the second tape member 41B of the above-described third embodiment. Similar changes may also be made to the exterior member 26A of the above-described second embodiment and the exterior member 26B of the above-described third embodiment. That is, the exterior member may be formed by combining any first tape member among the first tape members 31, 31A, and 31B and any second tape member among the second tape members 41, 41A, and 41B.
The first tape member 31 of the above-described first embodiment may also further include protruding portions that extend in the length direction Ld or protruding portions that extend in a direction inclined with respect to both the width direction Wd and the length direction Ld, in addition to the protruding portions 36 that extend in the width direction Wd. The second tape member 41 may also be changed in the same way. Similar changes may also be made in the above-described second embodiment and the above-described third embodiment.
In the above-described first embodiment, each of the protruding portions 36 and 46 may also be somewhat curved, as long as they extend along the width direction Wd. In the above-described second embodiment, each of the protruding portions 36A and 46A may also be somewhat curved, as long as they extend along the length direction LdA. In the above-described third embodiment, each of the protruding portions 36B, 46B may be somewhat curved, as long as they extend along the reference directions S1 and S2.

As shown in the cross-sectional views of FIGS. 2, 8 and 17, each of the plurality of protruding portions 36, 36A, 46, and 46A may have a U-shaped cross-sectional shape that has a pair of side wall portions that oppose each other, and the inner surfaces of the pair of side walls of each protruding portion may also be formed so as to be at least partially or entirely in surface contact with each other. This configuration is advantageous in improving the strength or elastic repulsion in the protruding direction of each of the protruding portions 36, 36A, 46, and 46A. Each of the plurality of protruding portions 36, 36A, 46, and 46A may be referenced as a U-shaped fold that has a curved head or top portion pointing away from the electric wires 22, and two flat legs that each extend from the head or the top toward the electric wires 22.

### LIST OF REFERENCE NUMERALS

20, 20A, 20B, 20C, 20D, 20E, 20F, 20G Wire harness
21 Electric wire bundle
22 Electric wire
23 Core wire
24 Insulating coating
25 Flat portion
26, 26A, 26B, 26C, 26D, 26E, 26F, 26G, 26H Exterior member
31, 31A, 31B First tape member (protective tape member)
32, 32A, 32B First base material (base material)
33 First adhesive layer (adhesive layer)
34, 34A, 34B First surface
35, 35A, 35B Second surface
36, 36A, 36B Protruding portion
37 First adhesion portion (adhesion portion)
37C Adhesion portion
41, 41A, 41B Second tape member (protective tape member)
41E Second tape member
42, 42A, 42B Second base material (base material)
42E Second base material
43 Second adhesive layer (adhesive layer)
43E Second adhesive layer
44, 44A, 44B First surface
45, 45A, 45B Second surface
46, 46A, 46B Protruding portion
47 Second adhesion portion (adhesion portion)
51 Protective tape member
52, 52A Band material
53 Adhesive layer
54 First surface
55 Second surface
56 Protruding portion
58 Paper tube
61,63 Accommodation portion
62,64 End portion affixing portion
71 Protective tape member
72 Base material
73 Adhesive layer
74 First surface
75 Second surface
76 Protruding portion
T1 Thickness
T2 Maximum thickness
T3 Maximum thickness
T4 Maximum thickness
L1 Center line
Ld, LdA, LdB Length direction
Td, TdA, TdB Thickness direction
Wd, WdA, WdB Width direction
S1, S2 Reference direction
X Extension direction
Y First direction
Z Second direction

1. A protective tape member for protecting at least one electric wire from foreign matter that comes into contact with a wire harness including the at least one electric wire, comprising:
a base member that is band-shaped and has a first surface and a second surface on a side opposite to the first surface; and an adhesive layer laminated on the second surface,
wherein a length direction of the base material is a direction orthogonal to a width direction of the base material,
the base material has, on the first surface, a plurality of protruding portions extending continuously along the width direction of the base material, and
the plurality of protruding portions are arranged side by side in the length direction of the base material.

2. The protective tape member according to claim 1,
wherein both end regions of the base member in the length direction include adhesion portions at which both end regions of the base material in the length direction of the base material are adhered to an outer peripheral surface of the at least one electric wire by the adhesive layer.

3. A protective tape member for protecting at least one electric wire from foreign matter that comes into contact with a wire harness including the at least one electric wire, comprising:
a base member that is band-shaped and has a first surface and a second surface on a side opposite to the first surface; and an adhesive layer laminated on the second surface,
wherein a length direction of the base material is a direction orthogonal to a width direction of the base material,
the base material has, on the first surface, a plurality of protruding portions extending continuously along the length direction of the base material, and
the plurality of protruding portions are arranged side by side in the width direction of the base material.

4. The protective tape member according to claim 3,
the protective tape member being used as at least one of two tape members in an exterior member formed by the two tape members, which are affixed to each other while sandwiching the at least one electric wire from both sides in a direction orthogonal to the length direction of the at least one electric wire,
the protective tape member further comprising: an accommodation portion that is recessed in a direction from the second surface to the first surface, extends in the length direction of the base material, and in which a portion of the at least one electric wire in the length direction is arranged; and end portion affixing portions that are located on both sides of the accommodation portion in the width direction of the base material and are affixed to the partner-side tape member by the adhesive layer.

5. A protective tape member for protecting at least one electric wire from foreign matter that comes into contact with a wire harness including the at least one electric wire, comprising:
a base member that is band-shaped and has a first surface and a second surface on a side opposite to the first surface; and an adhesive layer laminated on the second surface,
wherein a length direction of the base material is a direction orthogonal to a width direction of the base material,
the base material has, on the first surface, a plurality of protruding portions extending continuously along a reference direction that intersects the direction of the base material and intersects the length direction of the base material in a view from the thickness direction of the base material, and
the plurality of protruding portions are arranged side by side in the length direction of the base material.

6. A wire harness comprising an electric wire bundle including a plurality of electric wires,
wherein the electric wire bundle includes a flat portion in which the plurality of electric wires are arranged side by side in a flat manner, in at least a portion in a direction in which the electric wire bundle extends,
the wire harness further comprises an exterior member that protects the flat portion,
the exterior member has a first tape member and a second tape member that sandwich the flat portion from both sides of the flat portion in a thickness direction,
the first tape member is the protective tape member according to claim 1, which is affixed to the flat portion by the adhesive layer, and
the second tape member is the protective tape member according to claim 1, which is affixed to the flat portion by the adhesive layer.

7. A wire harness comprising an electric wire bundle including a plurality of electric wires,
wherein the electric wire bundle includes a flat portion in which the plurality of electric wires are arranged side by side in a flat manner, in at least a portion in a direction in which the electric wire bundle extends,
the wire harness further comprises an exterior member that protects the flat portion,
the exterior member has a first tape member and a second tape member that sandwich the flat portion from both sides of the flat portion in a thickness direction,
the first tape member is the protective tape member according to claim 3, which is affixed to the flat portion by the adhesive layer, and
the second tape member is the protective tape member according to claim 3, which is affixed to the flat portion by the adhesive layer.

8. A wire harness comprising an electric wire bundle including a plurality of electric wires,
wherein the electric wire bundle includes a flat portion in which the plurality of electric wires are arranged side by side in a flat manner in at least a portion in a direction in which the electric wire bundle extends,
the wire harness further comprises an exterior member that protects the flat portion,
the exterior member has a first tape member and a second tape member that sandwich the flat portion from both sides of the flat portion in a thickness direction,
each of the first tape member and the second tape member is the protective tape member according to claim 5, which is affixed to the flat portion by the adhesive layer.

9. A wire harness comprising an electric wire bundle including a plurality of electric wires,
wherein the electric wire bundle includes a flat portion in which the plurality of electric wires are arranged side by side in a flat manner in at least a portion in a direction in which the electric wire bundle extends,
the wire harness further comprises an exterior member that protects the flat portion,
the exterior member has a first tape member and a second tape member that are affixed to each other sandwiching the flat portion from both sides of the flat portion in a thickness direction,
the first tape member is the protective tape member according to claim 1, which is affixed to the flat portion by the adhesive layer, and
letting the base material of the first tape member be a first base material and the adhesive layer of the first tape member be a first adhesive layer,
the second tape member includes a second base material that is band-shaped and thinner than the first base material, and a second adhesive layer that is laminated on one surface of the second base material.

10. A wire harness comprising:
at least one electric wire; and
an exterior member formed by the protective tape member according to claim 5,
wherein the protective tape member is spirally wrapped around an outer periphery of the at least one electric wire such that portions of the protective tape member in the width direction overlap.

11. The wire harness according to claim 10,
wherein
each of the plurality of protruding portions extends along the length direction of the at least one electric wire in the outer periphery of the at least one electric wire.
